(19) United States
(12) Patent Application Publication
(10) Pub. No.: US 2023/0288088 A1
(43) Pub. Date: Sep. 14, 2023

(54) WIRELESS HVAC MONITORING TECHNIQUES

(71) Applicant: Alarm.com Incorporated, Tysons, VA (US)

(72) Inventors: Jackson Alexander Klein, Reston, VA (US); Craig Carl Heffernan, Oregon City, OR (US); Daniel Marc Goodman, Needham, MA (US); Andrew Tekle-Shirley, Washington, DC (US); Robert Nathan Picardi, Herndon, VA (US); Liam Shea Daly, Needham, MA (US); Grant Rudd, Braintree, MA (US)

(21) Appl. No.: 18/181,126

(22) Filed: Mar. 9, 2023

Related U.S. Application Data
(60) Provisional application No. 63/318,097, filed on Mar. 9, 2022.

(51) Int. Cl. F24F 11/56; F24F 11/80

(52) U.S. Cl. CPC F24F 11/56; F24F 11/80; F24F 2110/10

(57) ABSTRACT

Methods, systems, and apparatus, including computer programs encoded on computer-storage media, for monitoring and operations of a wireless HVAC system. In some implementations, a method includes determining that a thermostat associated with the property is presently unavailable to send or receive a wireless communication; obtaining temperature data collected by one or more sensors located at the property; identifying one or more models for temperature monitoring at the property; determining an operation to be performed by an HVAC system based on the temperature data and the one or more models; and providing data indicating the operation to the HVAC system.

### CROSS-REFERENCE TO RELATED APPLICATION

This application claims the benefit of U.S. Provisional Application No. 63/318,097, filed Mar. 9, 2022, the contents of which are incorporated by reference herein.

### TECHNICAL FIELD

This disclosure relates to home monitoring technology.

### BACKGROUND

A multi-zone heating, ventilation, and air conditioning (HVAC) system is one in which a conditioned space can have multiple thermostats located in different zones representing distinct areas or regions of a property. Each zone can have an air baffle that either allows forced air to the zone or not depending on whether or not it is open. Alternatively, in a boiler system, a zone can have a valve controlling whether or not hot water is supplied to the zone. This equipment often communicates to a control board associated the HVAC unit via physical thermostat wiring. A zone control board includes logic that determines whether to operate the HVAC system and which air duct baffles and/or boiler valves to open based on inputs from each of the thermostats.

### SUMMARY

This disclosure is focused on wireless HVAC zone control systems and associated techniques for HVAC monitoring. The wireless HVAC zone control systems can include a portable thermostat configured to provide functionality relating to a control unit (e.g., initiating a heating/cooling operation, setting a thermostat set point temperature) while also providing an interface for user interaction. The portable thermostat can be configured to a control dock that allows the portable thermostat to be physically connected to an HVAC system in a similar manner as a control unit. The portable thermostat also includes wireless functionality (e.g., Bluetooth, WiFi) such that the portable thermostat can wirelessly communicate with monitoring system devices (e.g., sensors, user devices) and control an HVAC system based on the wireless communications. For example, the portable thermostat can wirelessly communicate with a temperature sensor and determine that a measured air temperature is below a set point temperature. The portable thermostat can wirelessly relay a command to the control dock that configures the HVAC system to initiate a heating operation. In this example, wireless functionality of the portable thermostat enables HVAC system control without strictly requiring the thermostat to be physically connected to the HVAC system.

The portable thermostat can be configured to provide different monitoring capabilities based on its wireless functionality. For example, in some implementations, the portable thermostat provides ultra-localized temperature control within a property. The portable thermostat can include wireless radio technology to create intelligent, localized control over an HVAC system by monitoring data generated by sensors and/or devices in specific locations within a property. For example, the portable thermostat can monitor connection events with a user device to passively determine if a property is presently occupied and then use this passive determination to adjust HVAC operations (e.g., adjusting a set point temperature when a property is presumed unoccupied for energy conservation). As another example, the portable thermostat can classify different types of sensors and/or devices located within a property (e.g., stationary, mobile, wearable) and use data obtained from each type of device to provide fine-tuned temperature control (e.g., adjusting a set point temperature for a specific region of a property based on predicting that a user is occupying that specific region of the property).

In some other implementations, the systems disclosed herein can be configured to provide failsafe mechanisms in the event that a portable thermostat is presently unavailable and/or unable to communicate with other devices of a monitoring system. In such circumstances, the systems may use machine learning models relating to HVAC operation to predict how an HVAC system should be controlled and/or configured based on monitoring data collected by sensors and/or devices associated with a property. The sensor data can include data indicating environmental conditions with a property, external weather data associated with a property, usage data associated with devices or features within a property, among others. For example, a monitoring system can apply a machine learning model that correlates temperature data of an unconditioned space in a property and temperature data of a conditioned space in the property. In this example, the system uses the correlation specified by the machine learning model to determine how to adjust HVAC system operation in relation to regulating temperature in the unconditioned space. As another example, a monitoring system can apply a machine learning model that correlates HVAC system run time with an outdoor temperature and a desired internal temperature. In this example, the correlation is generated during normal operation and used to predict how to adjust an HVAC system when similar conditions (e.g., similar outdoor temperature, similar desired internal temperature) are present.

Implementations of the described techniques may include hardware, a method or process implemented at least partially in hardware, or a computer-readable storage medium encoded with executable instructions that, when executed by a processor, perform operations.

One innovative aspect of the subject matter described in this specification is embodied in a method that includes regulating temperature at a property, the method including: determining that a thermostat associated with a property is presently unavailable to send or receive a wireless communication; obtaining temperature data collected by one or more sensors located at the property; identifying one or more models for temperature monitoring at the property; determining an operation to be performed by an HVAC system based on the temperature data and the one or more models; and providing data indicating the operation to the HVAC system.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, the one or more models include a machine learned model trained to predict a temperature of a conditioned space.

In some implementations, the one or more models include a statistical correlation model to predict a temperature of a conditioned space.

In some implementations, the one or more models correlate temperature data between conditioned and unconditioned spaces at the property.

In some implementations, the HVAC system is located in an unconditioned space of the unconditioned spaces.

In some implementations, the operation to be performed by the HVAC system includes one or more of (i) initiating or terminating a heating or cooling operation, (ii) adjusting an operating mode of the HVAC system, (iii) adjusting configurations of one or more components of the HVAC system, or (iv) adjusting a set point temperature of the HVAC system.

In some implementations, determining that the thermostat associated with the property is presently unavailable to exchange wireless communications includes determining a control unit of the HVAC system is unable to establish a local wireless connection with the thermostat.

In some implementations, determining that the thermostat associated with the property is presently unavailable to exchange wireless communications includes monitoring wireless connections over a local area network of the property.

In some implementations, actions include updating the one or more models for temperature monitoring at the property.

In some implementations, actions include obtaining data from other properties; and updating the one or more models for temperature monitoring at the property using the obtained data from the other properties.

In some implementations, obtaining the temperature data collected by the one or more sensors located at the property includes obtaining data from a temperature sensor indicating an air temperature in an unconditioned space.

In some implementations, determining the operation to be performed by the HVAC system based on the temperature data and the one or more models includes obtaining a set point temperature from the one or more models using the temperature data; and determining the operation to be performed by the HVAC system as (i) a cooling operation if the set point temperature is below an air temperature indicated by the temperature data.

In some implementations, determining the operation to be performed by the HVAC system based on the temperature data and the one or more models includes obtaining a set point temperature from the one or more models using the temperature data; and determining the operation to be performed by the HVAC system as (i) a heating operation if the set point temperature is above an air temperature indicated by the temperature data.

In some implementations, providing the data indicating the operation to the HVAC system includes providing data indicating the operation to a control dock associated with the HVAC system.

In some implementations, actions include obtaining weather data for the property; and determining the operation to be performed by the HVAC system includes determining the operation to be performed by the HVAC system based on (i) the temperature data, (ii) the one or more models, and (iii) the obtained weather data.

In some implementations, determining that the thermostat associated with the property is presently unavailable to send or receive the wireless communication includes determining the thermostat is unavailable to send or receive one or more particular types of wireless communications. In some implementations, the thermostat is a portable thermostat.

The details of one or more implementations are set forth in the accompanying drawings and the description, below. Other potential features and advantages of the disclosure will be apparent from the description and drawings, and from the claims.

### BRIEF DESCRIPTION OF DRAWINGS

FIG. 1 shows an example of a monitoring system that includes a portable thermostat.

FIGS. 2A-2C show examples of different configurations of a portable thermostat. FIG. 2A shows the portable thermostat operating in a wireless connectivity mode. FIG. 2B shows the portable thermostat operating in a wired (docked mode) with a control dock associated with an HVAC system. FIG. 2C shows an example in which the portable thermostat is configured to operate in a property with multiple HVAC systems.

FIGS. 3A-3C show examples of temperature monitoring techniques based on communications between a portable thermostat and wearable temperature sensors within a property. FIG. 3A shows an example of how the portable thermostat can classify different types of sensors (e.g., stationary, mobile, wearable). FIG. 3B shows an example of a technique of passively adjusting temperature monitoring using user movement within a property. FIG. 3C shows an example of a technique of predicting occupancy of a property based on connectivity between a portable thermostat and nearby wearable temperature sensors.

FIGS. 4A-4D show examples of monitoring scenarios in which a portable thermostat loses connectivity with a control dock associated with an HVAC system. FIG. 4A shows an example of a scenario in which the portable thermostat is unavailable and a model correlating temperature data between conditioned and unconditioned spaces is applied to predict the temperature of a conditioned space. FIG. 4B shows an example of a table with how a control unit operates in the monitoring scenario shown in FIG. 4A.

FIG. 4E shows an example of a scenario in which the portable thermostat is unavailable and a model correlating outdoor temperature data, indoor temperature data, and HVAC runtime activity is applied to control an HVAC system. FIG. 4D shows an example of a table with how a control unit operates in the monitoring scenario shown in FIG. 4B.

FIG. 5 shows an example of a process for determining an HVAC operation to be performed based on monitoring temperature data generated by environmental sensors of a property.

In the drawings, like reference numbers represent corresponding parts throughout.

### DETAILED DESCRIPTION

In general, this disclosure describes wireless HVAC zone control systems and associated techniques for HVAC monitoring. The wireless HVAC zone control systems can include a portable thermostat configured to provide functionality relating to a control unit (e.g., initiating a heating/cooling operation, setting a thermostat set point temperature) while also providing an interface for user interaction. The portable thermostat can be configured to a control dock that allows the portable thermostat to be physically connected to an HVAC system in a similar manner as a control unit. The portable thermostat also includes wireless functionality (e.g., Bluetooth, WiFi) such that the portable thermostat can wirelessly communicate with monitoring system devices (e.g., sensors, user devices) and control an HVAC system based on the wireless communications. For example, the portable thermostat can wirelessly communicate with a temperature sensor and determine that a measured air temperature is below a set point temperature. The portable thermostat can wirelessly relay a command to the control dock that configures the HVAC system to initiate a heating operation. In this example, wireless functionality of the portable thermostat enables HVAC system control without strictly requiring the thermostat to be physically connected to the HVAC system.

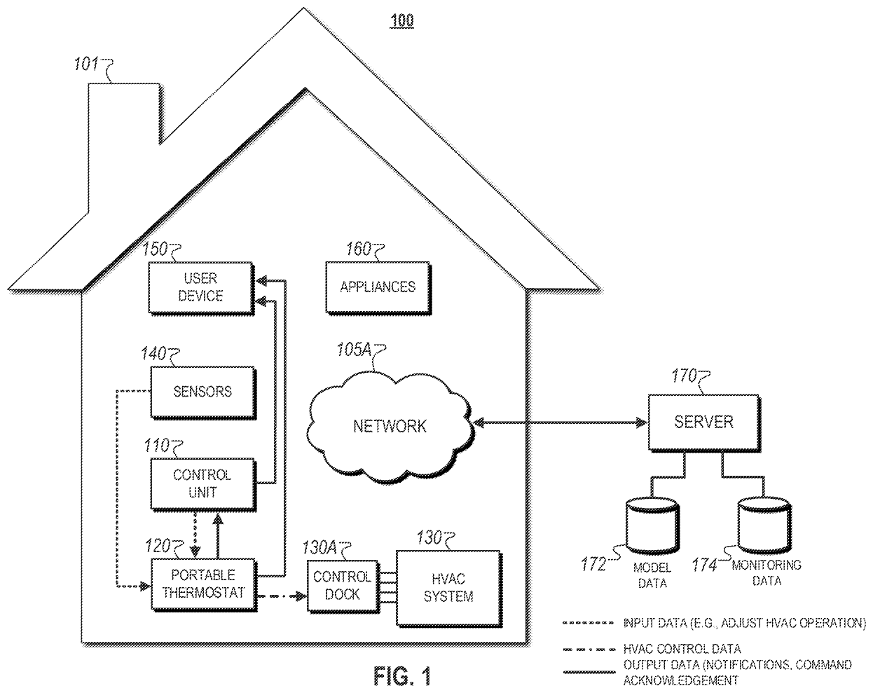

FIG. 1 shows an example of a monitoring system 100 that includes a portable thermostat. The system 100 is located in a property 101 and associated with a server 170. The system 100 includes control unit 110, a portable thermostat 120, a control dock 130A, an HVAC system 130, sensors 140, a user device 150, and appliances 160. The server 170 stores data associated with system 100, such as model data 172 and monitoring data 174.

The network 105 may be configured to enable electronic communications between electronic devices. For example, the network 105 may be configured to enable exchange of electronic communications between the control unit 110, the portable thermostat 120, the control dock 130A, the HVAC system 130, the sensors 140, the user device 150, appliances 160, and the server 170. The network 105 may include local area networks (LANs), Wi-Fi, or analog or digital wired and wireless networks. The network 105 may include multiple networks or subnetworks, each of which may include, for example, a wired or wireless data pathway. The network 105 may also include a circuit-switched network, a packet-switched data network, or any other network able to carry electronic communications (e.g., data or voice communications). For example, the network 105 may include networks based on the Internet protocol (IP), or other comparable technologies. In some examples, the network 105 may include wide area networks (WAN) of computers that receive services provided by a service provider.

The control unit 110 can be a computing device that controls aspects of monitoring operations performed by the components of the system 100. The control unit 110 can include a controller and a network module. The controller can be configured to control, for example, temperature monitoring and adjustment by HVAC system 130. In some examples, the controller includes a processor or other control circuitry configured to execute instructions of a program that controls operation of the system 100. In these examples, the controller can be configured to receive input from sensors, detectors, or other devices associated with the system 100 and control operation of components of the system 100, such as a camera, a temperature sensor, an activity sensor, HVAC components, etc. For example, the controller may be configured to control operation of the network module included in the control unit 110.

The network module of the control unit 110 can be a communication device configured to exchange communications over the network 105. The network module can be a wireless communication module configured to exchange wireless communications over the network 105. For example, the network module can be a wireless communication device configured to exchange communications over a short-range wireless network. The network module can also be configured to exchange communications over the network 105 using a wireless connection. For instance, the network module can enable the control unit 110 to exchange communications with the server 170 over the network 105 without the use of the network 105. The wireless communication device can include one or more GSM modules, a radio modem, a cellular transmission module, or any type of module configured to exchange communications in one of the following formats: LTE, GSM or GPRS, CDMA, EDGE or EGPRS, EV-DO or EVDO, UMTS, IP, or Wi-Fi.

The network module can also may be a wired communication module configured to exchange communications over the network 105 using a wired connection. For instance, the network module can be a modem, a network interface card, or another type of network interface device. The network module can be an Ethernet network card configured to enable the control unit 110 to communicate over a local area network and/or the Internet. The network module can also be a voiceband modem configured to enable an alarm panel to communicate over the telephone lines of Plain Old Telephone Systems (POTS). In some implementations, the alarm panel may be a broadband or cellular gateway where the network module may enable the control unit 110 to communicate over the network 105.

The control unit 110 can communicate devices located in property 101. For example, control unit 110 can communicate with portable thermostat 120, control dock 130A, HVAC system 130, sensors 140, user device 150, and appliances 160 over network 105. In some instances, the control unit 110 may periodically receive data activity reports from portable thermostat 120, control dock 130A, HVAC system 130, sensors 140, user device 150, and appliances 160. The data activity reports can include information related to property 101, such as occupancy data, activity data, movement data, temperature data, among others.

The portable thermostat 120 can be a portable temperature regulating device that is configured to control the operations of the HVAC system 130. For example, the portable thermostat 120 can regulate and/or adjust the air temperature within the property 101 by transmitting control signals to the HVAC system 130 to initiate or terminate heating or cooling operations. As discussed throughout, the portable thermostat 120 can use wired and wireless communication protocols to communicate with the HVAC system 130. For example, when the portable thermostat 120 is configured to the control dock 130A (e.g., via physical attachment in a “docked” mode), the portable thermostat 120 can communicate with the HVAC system 130 via wires connecting the control dock 130A and the HVAC system 130 components. As another example, when the portable thermostat 120 is detached from the control dock 130A, the portable thermostat 120 can wirelessly transmit control signals to the control dock 130A, which then relays the control signals to the HVAC system 130.

The HVAC system 130 can be a control system within the property 101 that includes one or more components that perform operations related to thermal comfort, ventilation, indoor air quality and infiltration monitoring, and/or pressure maintenance. In some implementations, the HVAC system 130 is also configured to monitor energy consumption of individual system components, for example, by directly measuring the energy consumption of the HVAC system 130 components or by estimating the energy usage of the one or more HVAC system 130 components based on detecting usage of components of the HVAC system 130.

The sensors 140 may include various types of sensors that are placed within a property. For example, the sensors 140 can include a contact sensor, a motion sensor, a glass break sensor, an occupancy sensor, an activity sensor, or any other type of sensor that is typically included in a monitoring system or security system. The sensors 140 also can also include environmental sensors such as an ambient temperature sensor, a water sensor, a rain sensor, a wind sensor, a light sensor, a smoke detector, a carbon monoxide detector, an air quality sensor, etc.

The user device 150 can be a computing device associated with a user, such as a smartphone, a tablet computing device, a laptop, or a desktop computing device. The user device 150 can be configured to run an application (e.g., a mobile application associated with server 170 acting as an application server) that provides the user with access to functionality relating to the portable thermostat 120. For example, the user can use the user device 150 to access an interface that permits remote control of the portable thermostat 120 and/or the HVAC system 130 (via the portable thermostat 120 to relay commands to the HVAC system 130).

The appliances 160 can be home automation devices connected to the network 105 that are configured to exchange electronic communications with other devices of the system 100. The appliances 160 may include, for example, connected kitchen appliances, controllable light sources, safety and security devices, energy management devices, and/or other types of electronic devices capable of exchanging electronic communications over the network 105. In some instances, the appliances 160 may periodically transmit information and/or generated data to the control unit 110 such that the control unit 110 can automatically control the operation of the appliances 160 based on the exchanged communications. For example, the control unit 110 can operate one or more of the appliances 160 based on a fixed schedule specified by the user. In another example, the control unit 110 may enable or disable one or more of the appliances 160 based on received sensor data from the sensors 140.

The server 170 can be an electronic device configured to provide monitoring services by exchanging electronic communications with the control unit 110, portable thermostat 120, control dock 130A, HVAC system 130, sensors 140, user device 150, and appliances 160 over the network 105. For example, the server 170 can be configured to monitor events, e.g., a measured user temperature satisfying a threshold, generated by the control unit 110 and/or other devices connected over the network 105. In this example, the server 170 may exchange electronic communications with the network module included in the control unit 110 to receive information regarding events detected by the control unit 110. The server 170 can also receive information regarding events from the HVAC system 130, e.g., current ambient temperature, current set point temperature, heating/cooling rate associated with ongoing HVAC operations, changes in ambient temperature, changes in set point temperature, among others.

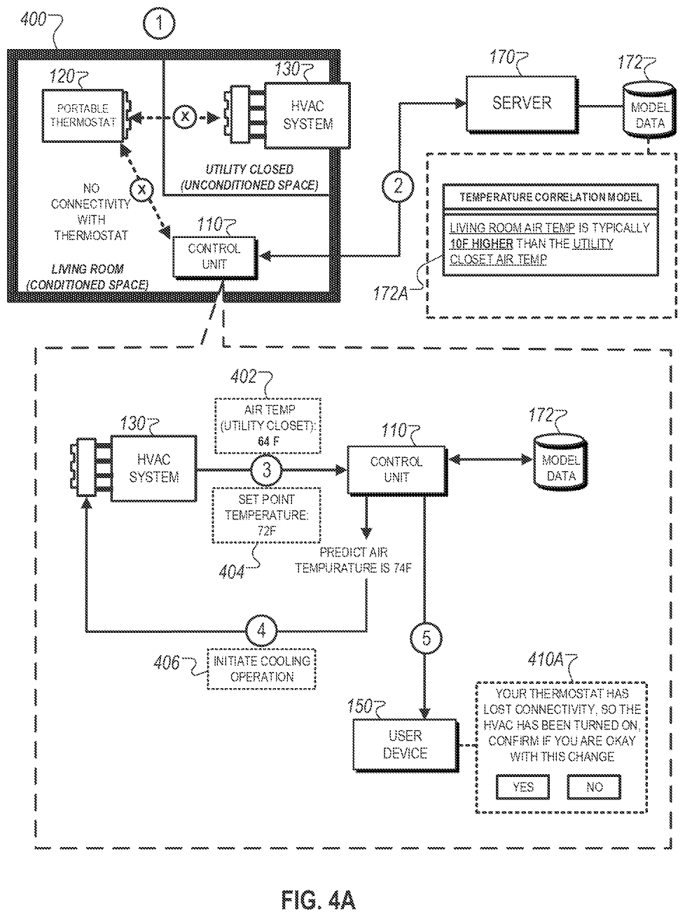

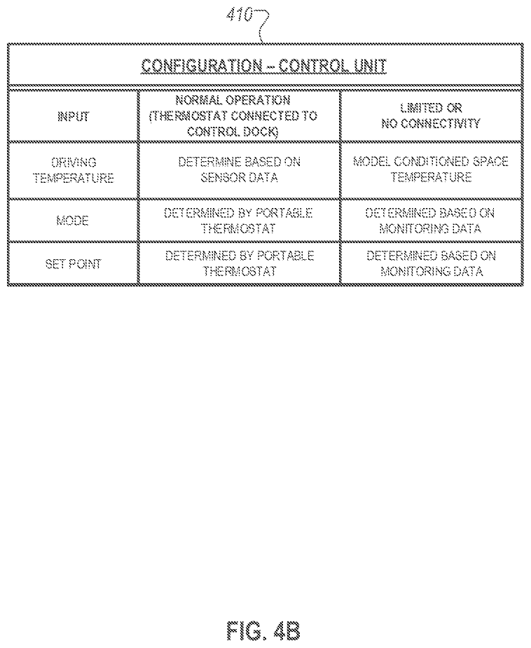

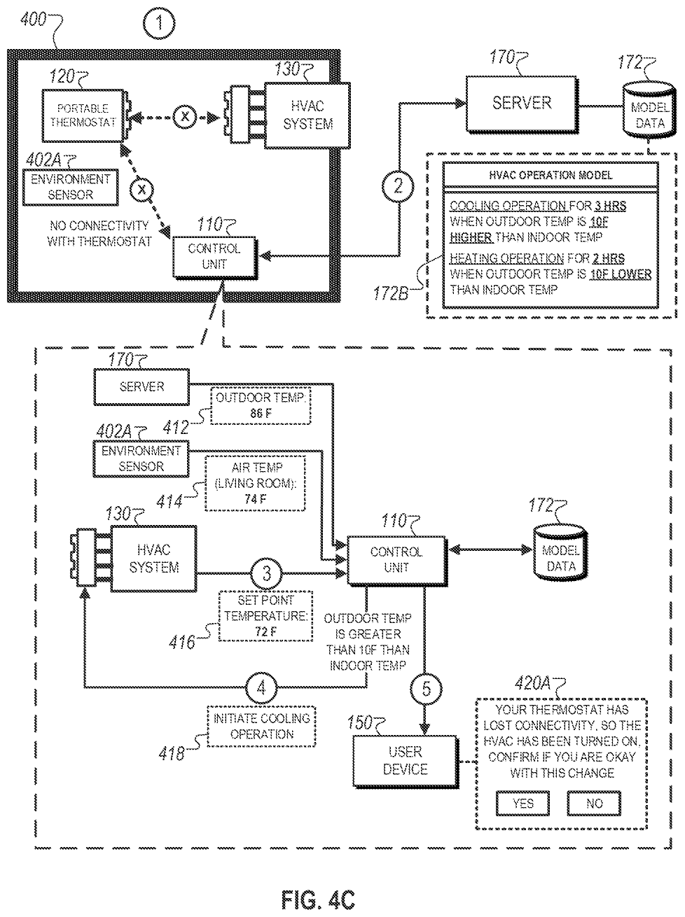

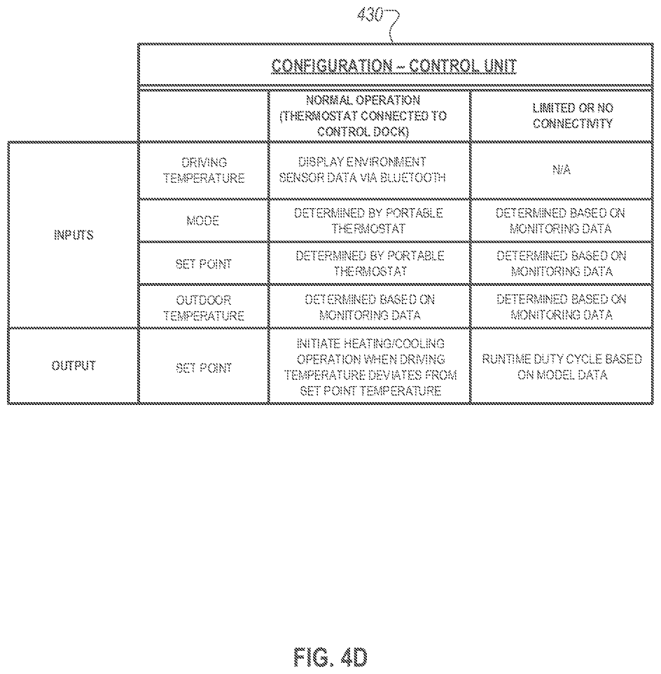

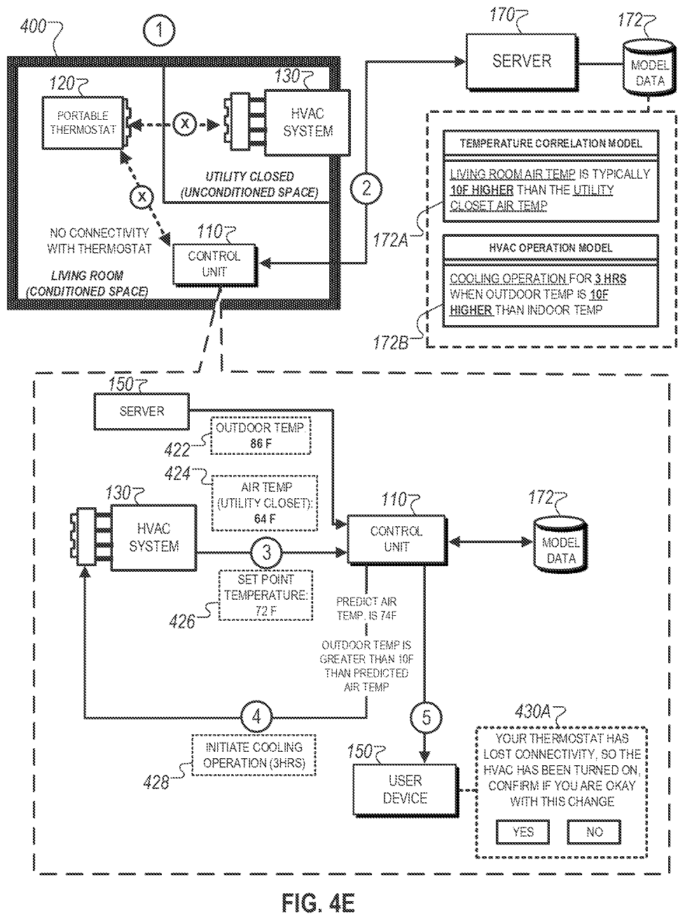

The server 170 can store data that is used to perform set point temperature adjustment in the manner discussed throughout. For example, the server 170 can store model data 172 and monitoring data 174. Model data 172 can include one or more models that can be used to control the HVAC system 130 when the portable thermostat 120 is unavailable. For example, as discussed in reference to FIG. 4A, model data 172 can include a model for predicting the temperature of a conditioned space. In this example, the HVAC system 130 can be located in an unconditioned space that may not necessarily be similar to the air temperature monitored by portable thermostat 120 within a conditioned space. In such scenarios, the model can correlate temperature data between conditioned and unconditioned spaces, which allows the system to predict the air temperature in the unconditioned space when the portable thermostat 120 is unavailable. As another example, as discussed in reference to FIG. 4C, model data 172 can include a model for predicting how to adjust a configuration of an HVAC system 130 based on indoor temperature, outdoor temperature, and historical data relating to HVAC operations.

Monitoring data 174 can include data collected by the monitoring system located at property 101. The monitoring data 174 can include various types of monitoring metrics, such as indoor air temperature, set point temperature, time periods associated with heating/cooling operations, number of set point temperature adjustments, among others. In some instances, the system uses monitoring data 174 to provide functionality relating to the portable thermostat 120. For example, as discussed in reference to FIG. 4B, information specified by monitoring data 174 can be used to identify trends and/or patterns associated with HVAC system operation and thereby generate a model that correlates historical HVAC operation with indoor temperature, outdoor temperature, and other situations in property 101.

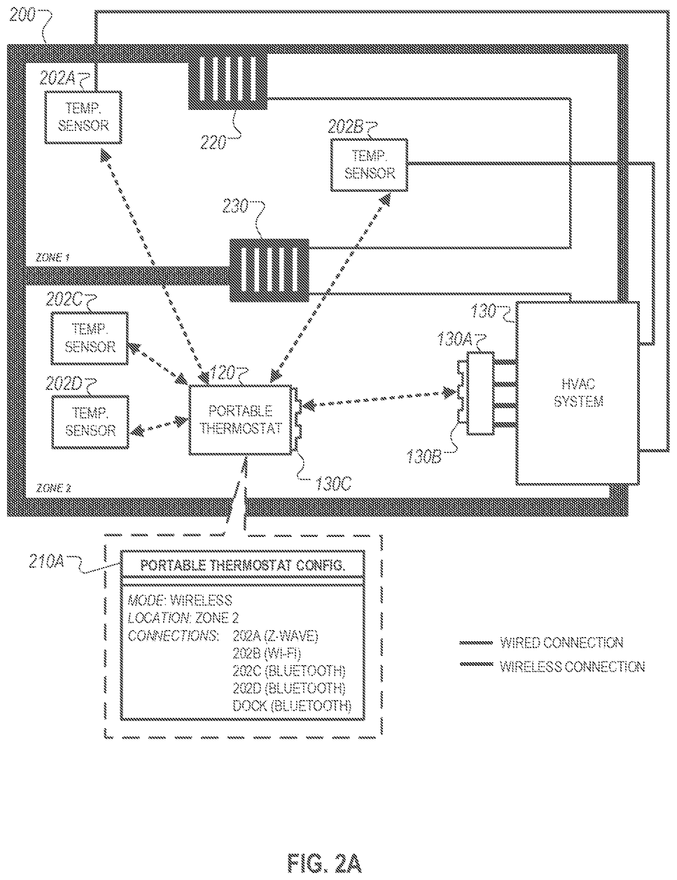

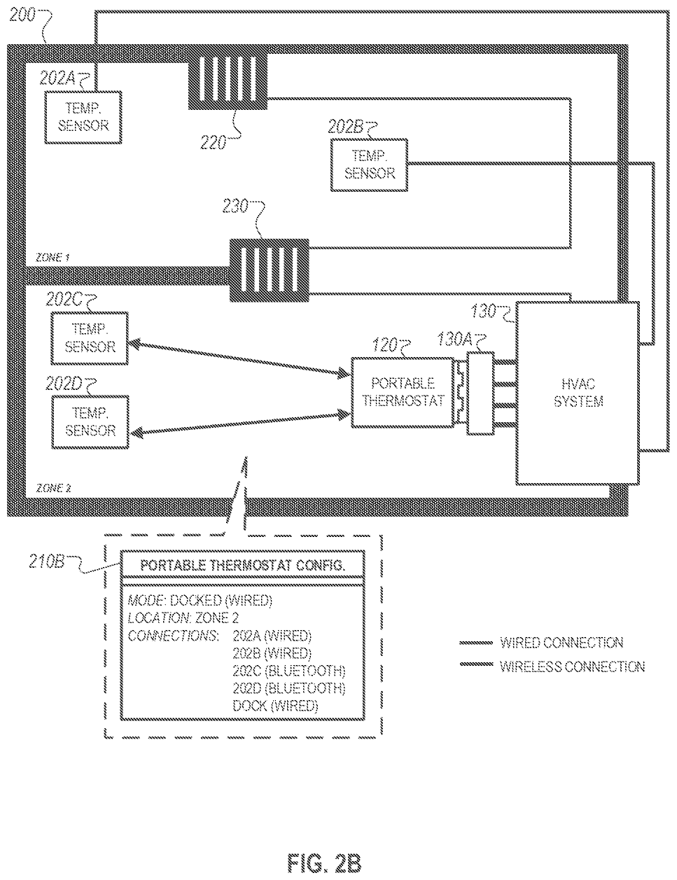

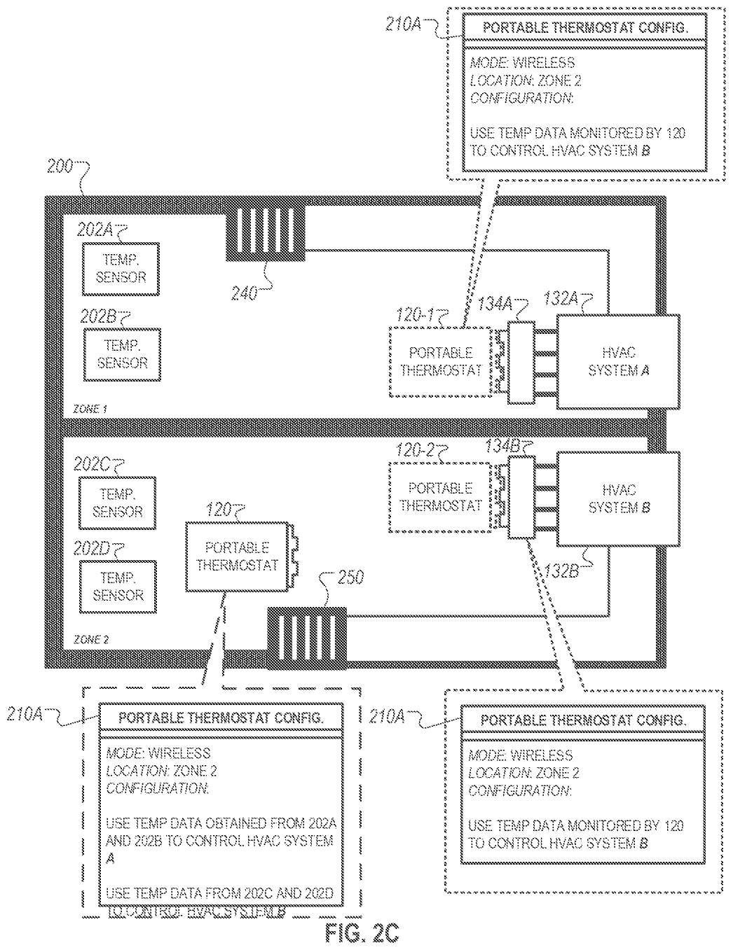

FIGS. 2A-2C show examples of different configurations of a portable thermostat. FIG. 2A shows an example in which portable thermostat 120 operates in a wireless connectivity (undocked) mode within property 200. In this example, portable thermostat 120 is removed from a docking interface 130B of control dock 130A and can thereby be moved to different regions of the property 200. Portable thermostat 120 includes radio modules enabling wireless communications with other devices located within property 200, such as temperature sensors 202A, 202B, 202C, and 202D. In the example shown in FIG. 2A, temperature sensors 202A and 202B are located in a first zone of property 200 (zone 1), while sensors 202C and 202D are located in a second zone of property 200 (zone 2). HVAC system 130 is configured as a multi-zone HVAC system and includes vent 220 for heating/cooling operations relating to zone 1 and vent 230 for heating/cooling operations relating to zone 2. As discussed throughout, HVAC system 130 is connected to control dock 130A via physical wiring. When portable thermostat 120 is docked to the control dock 130A via mating of interfaces 130B and 130C, portable thermostat 120 is physically connected to HVAC system 130.

As shown in FIG. 2A, portable thermostat 120 uses configuration 210A to wirelessly communicate with devices located in property 200. Configuration 210A identifies an operating mode of portable thermostat 120 (wireless), a device location (zone 2), and active connections (sensors 202A, 202B, 202C, 202D, dock). The configuration 210A also identifies a wireless communication protocol used by each wireless device (Z-Wave, Wi-Fi, Bluetooth). Using configuration 210A, portable thermostat 120 can obtain monitoring data collected by devices (e.g., temperature data collected a temperature sensor), and relay the obtained monitoring data. For example, if temperature data collected by sensors 202A and 202B are lower than a desired internal air temperature, then portable thermostat 120 may relay a command to control dock 130A and thereby configure HVAC system 130 to initiate heating operation in zone 2. In this example, the portable thermostat 120 uses wireless functionality to regulate temperature in a different zone of a property while undocked from control dock 130A.

The configuration shown in FIG. 2A can provide various advantages to temperature regulation within a property. For instance, since the portable thermostat 120 can wirelessly communicate with control dock 130A, a user can use the thermostat 120 as an HVAC controller without necessarily placing the device in a specific location. In some instances, this configuration also simplifies an initial installation of a monitoring system since an installer can customize the size of zones within a property. Additionally, a user can dynamically configure zones within a property by associating devices with zones in the configuration. This simplifies the process of adding a new zone within a property by adding a new temperature sensor. For example, if sensors 202A, 202B, 202C, and 202D are part of a Z-wave network, a user can add a new temperature sensor by associating it with the Z-wave network. Similarly, a user can introduce a new baffle or value to an existing duct system, update plumbing at a boiler into an existing wireless network.

FIG. 2B shows an example in which portable thermostat 120 operating in a docked (wired) mode with control dock 130A associated with HVAC system 130. In this example, portable thermostat 120 is docked to control dock 130A via a docking interface (e.g., docking interfaces 130B, 130C shown in FIG. 2A). As discussed in reference to FIG. 2A, portable thermostat 120 includes radio modules enabling wireless communications with other devices located within property 200, such as temperature sensors 202A, 202B, 202C, and 202D.

As shown in FIG. 2B, portable thermostat 120 uses configuration 210B to wirelessly communicate with devices located in property 200. Configuration 210B identifies an operating mode of portable thermostat 120 (wired), a device location (zone 2), and active device connections (devices 202A, 202B, 220C, 202D, dock). The configuration 210B also identifies a wireless communication protocol used by each wireless device (Z-Wave, Wi-Fi, Bluetooth). Using configuration 210B, portable thermostat 120 directly communicate with HVAC system 130 for controlling operations (e.g., initiating heating/cooling operations, setting a set point temperature). The portable thermostat 120 can also obtain monitoring data collected by devices (e.g., temperature data collected a temperature sensor) in a similar manner as discussed above for FIG. 2A.

FIG. 2C shows an example in which portable thermostat 120 is configured to operate in a property with multiple HVAC systems 132A, 132B. In this example, portable thermostat 120 is removed from docking interfaces of control docks 134A and 134B and can thereby be moved to different regions of the property 200. As discussed throughout, portable thermostat 120 includes radio modules enabling wireless communications with other devices located within property 200, such as temperature sensors 202A, 202B, 202C, and 202D. In the example shown in FIG. 2C, temperature sensors 202A and 202B are located in a first zone of property 200 (zone 1), while sensors 202C and 202D are located in a second zone of property 200 (zone 2). Property 200 includes distinct HVAC systems for each zone. For example, HVAC system 132A includes vent 240 for heating/cooling operations relating to zone 1 and HVAC system 132B includes vent 250 for heating/cooling operations relating to zone 2. HVAC systems 132A, 132B are connected to control docks 134A, 134B, respectively, via physical wiring. When portable thermostat 120 is docked to control dock 134A (configuration 120-1), portable thermostat 120 is physically connected to HVAC system 132A. Similarly, when portable thermostat 120 is docked to control dock 134B (configuration 120-2), portable thermostat 120 is physically connected to HVAC system 132B.

As shown in FIG. 2C, portable thermostat 120 uses configuration 210C to wirelessly communicate with devices located in zone 2 of property 200 when located in that zone. Configuration 210C identifies an operating mode of portable thermostat 120 (wireless) and a device location (zone 2). The configuration 210C also identifies the specific temperature data to be used in controlling each HVAC system. For example, temperature data obtained from sensors 202A and 202B are used to control HVAC system 132A while temperature data obtained from sensors 202C and 202D are used to control HVAC system 132B. In this example, the portable thermostat 120 can use wireless functionality to regulate temperature in each zone of a property using only relevant temperature data.

The configuration shown in FIG. 2C can provide various advantages to temperature regulation by multi-unit HVAC systems. For example, since each HVAC system is centrally controlled by portable thermostat 120, the system can run analytics dynamically to identify inefficiencies in each zone, and independently operate each HVAC system to overcome such inefficiencies. For example, if two zones are strongly associated with each other such that heating one zone will also generally heat the other zone, the portable thermostat 120 can determine to only initiate a heating operation in a single zone (rather than both) and run an HVAC system at a lower power to achieve the same temperature response in both zones.

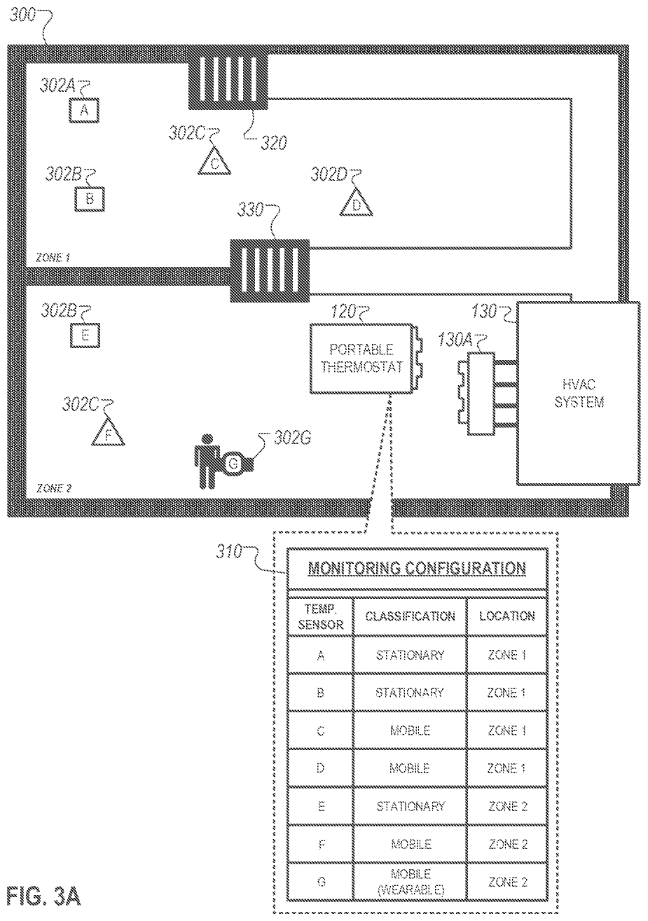

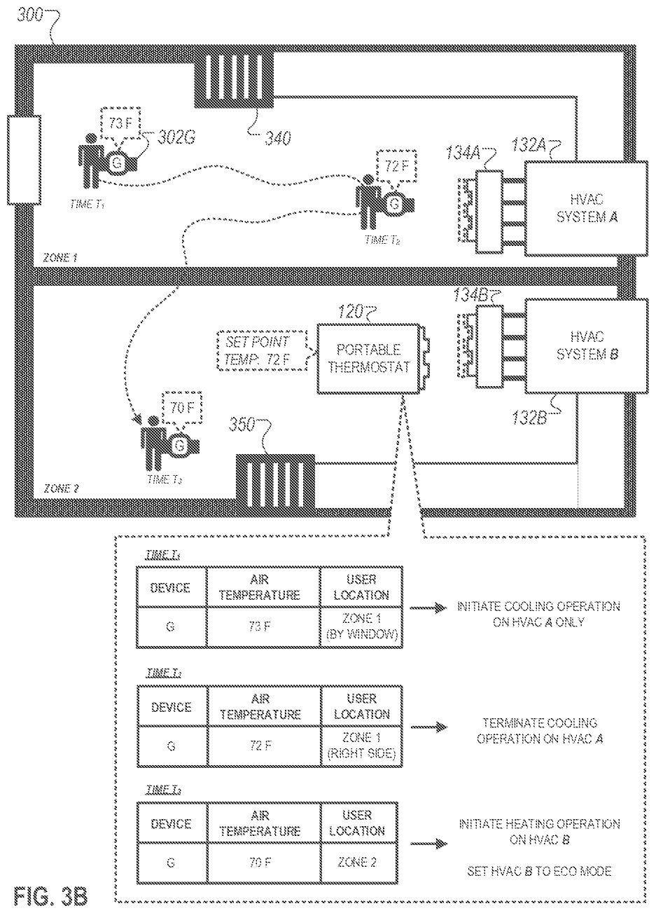

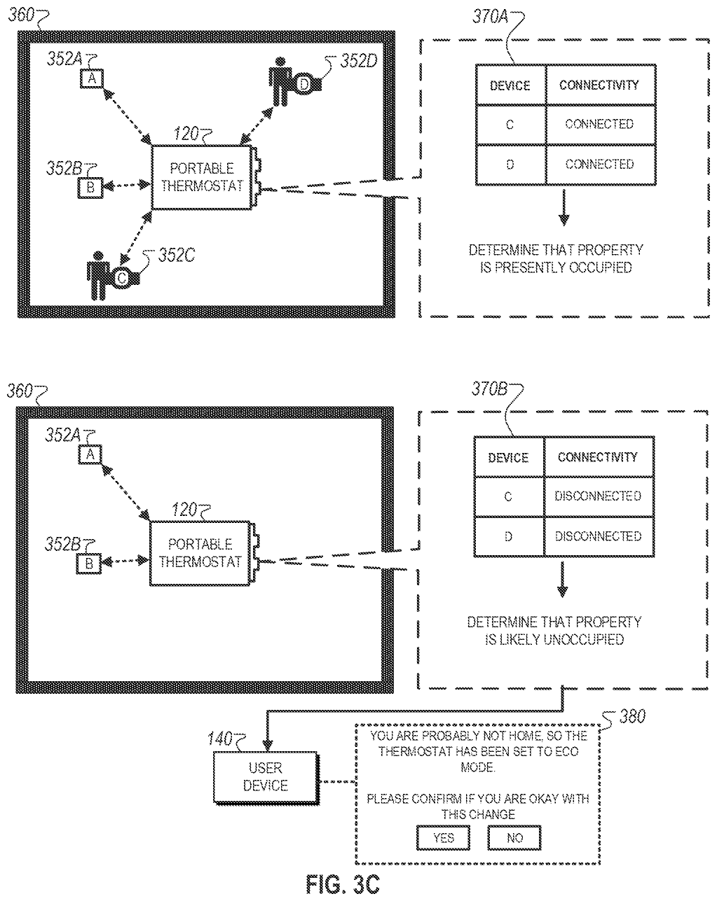

FIGS. 3A-3C show examples of temperature monitoring techniques based on communications between a portable thermostat and wearable temperature sensors within a property 300. FIG. 3A shows an example of how the portable thermostat can classify different types of sensors (e.g., stationary, mobile, wearable). In this example, portable thermostat 120 stores a monitoring configuration 310 classifying wireless devices that are detected in property 300. As shown, monitoring configuration 310 includes seven devices (devices 302A, 302B, 302C, 302D, 302E, 302F), and for each device, a device classification and a device location.

The portable thermostat 120 can use the information specified in monitoring configuration 310 to identify how to configure and/or adjust HVAC operations based on data obtained from wireless devices. For example, devices 302A and 302B are identified as stationary devices located in zone 1, so the portable thermostat 120 uses data obtained from these devices to primary adjust configuration of vent 320 or heating/cooling operations relating to zone 1. As another example, devices 302C, 302D, and 302F are identified as mobile devices, so the portable thermostat 120 monitors the locations of these devices in determining how data obtained from them are used to configure and/or adjust HVAC operations. As yet another example, device 302G is identified as a wearable device worn by a user, so the portable thermostat 120 uses data collected from this device to determine a present location of the user within property 300, a measured body temperature of the user, and/or how to adjust HVAC operation within the property 300 based on user preferences.

FIG. 3B shows an example of a technique of passively adjusting temperature monitoring using user movement within a property. In this example, portable thermostat 120 periodically tracks location of a wearable device 302G and using the tracked location to identify user location and/or user movement throughout the property 300. Since wearable device 302G can be configured as a wearable temperature sensor, the portable thermostat 120 can also monitor an air temperature and/or a body temperature of the user in parallel with tracking location. As shown, at time T₁, the portable thermostat 120 determines that the user is presently located in zone 1 (in particular, nearby the window) and that the air temperature nearby the wearable device 302G is 73 F. Based on this information, the portable thermostat 120 configures HVAC system 132A to initiate a cooling operation. The portable thermostat 120 determines this configuration based on the measured air temperature (73 F) being greater than a set point temperature of 70 F. In this scenario, the portable thermostat 120 does not adjust the configuration of HVAC system 132B since the user is not located in zone 2 of the property 300.

At time T2, the portable thermostat 120 determines that the user is still located in zone 1 but no longer near the window. Additionally, the air temperature nearby the wearable device 302G is 72 F. Based on this information, the portable thermostat 120 configures HVAC system 132A to terminate the cooling operation previously initiated at time T₁. The portable thermostat 120 determines this configuration based on the new location of the user within zone 1 (further from the window) and a lower measured air temperature (72 F), which indicates that the user may feel cold if the cooling operation is sustained in zone 1. Like the configuration in time T₁, the portable thermostat 120 does not adjust the configuration of HVAC system 132B since the user is not located in zone 2 of the property 300.

At time T3, the portable thermostat 120 determines that the user is now located in zone 2. Additionally, the air temperature nearby the wearable device 302G is now measured to be 70 F. Based on this information, the portable thermostat 120 configures HVAC system 132B to initiate a heating operation. The portable thermostat 120 also sets HVAC system 132A to “ECO mode,” which reduces energy consumption associated with HVAC system 132A while also maintaining the air temperature within zone 1. The portable thermostat 120 determines this configuration based on the new location of the user within zone 1 (in zone 2), a lower measured air temperature (70 F) in zone 2. This information indicates that the user may feel cold given the air temperature differential between zone 1 and zone 2. Additionally, since the user is no longer located in zone 1, the portable thermostat 120 determines that energy consumption associated with operation of HVAC system 132A may be wasteful.

FIG. 3C shows an example of a technique of predicting occupancy of a property 360 based on connectivity between portable thermostat 120 and nearby devices 352A, 352B, and 352C. In this example, devices 352A and 352B are stationary or mobile temperature sensors located in property 360 while devices 352C and 352D are wearable devices that are associated with occupants of property 360.

FIG. 3C shows two scenarios of predicting occupancy. In the first scenario, portable thermostat 120 uses configuration 370A to establish connection events with devices 352C and 352D (e.g., determining that devices 352C and 352D are within a certain proximity that enables establishing a wireless connection with them). In this scenario, the portable thermostat 120 determines that the property 360 is presently occupied since devices 352C and 352D are worn by users and their presence within the property 360 indicates that the associated users are also located in the property 360.

In the second scenario, portable thermostat 120 uses configuration 370B to determine that connection events are unable to be established with devices 352C and 352D (e.g., determining that devices 352C and 352D are not within a certain proximity that enables establishing a wireless connection with them). In this scenario, the portable thermostat 120 determines that the property 360 is presently unoccupied since devices 352C and 352D are not detected within the property and so their associated users are likely outside of the property 360. The portable thermostat 120 then uses this information to provide a notification 380 to user device 150. As shown, notification 380 requests a user to confirm the occupancy determination made by portable thermostat 120 based on information specified in configuration 370B. In this way, portable thermostat 120 can use input on user device 150 in response to notification 380 to confirm and/or correct occupancy determinations based on monitoring the presence of devices 352C and 352D in property 360.

FIGS. 4A-4E show examples of scenarios in which portable thermostat 120 loses connectivity. In these scenarios, a monitoring system uses various adaptation techniques so that the lack of availability of the portable thermostat 120 is not a bottleneck to temperature regulation within property 400. The adaptation techniques involve using a model (e.g., a machine learned model, a statistical correlation model) to predict how to adjust the operation of an HVAC system. Examples of adjustments include initiating or terminating a heating/cooling operation, adjusting an operating mode of the HVAC operation (e.g., ECO mode, AWAY mode, etc.), adjusting configurations of one or more components of the HVAC system (e.g., vents), adjusting a set point temperature of the HVAC system, among others.

In the example shown in FIG. 4A, a monitoring system uses a model 172A to predict the temperature of a conditioned space. In this example, the HVAC system 130 is located in an unconditioned space such as a utility closet. This space is unconditioned since it is separate from a conditioned space, such as a living room, that is actively monitored by portable thermostat 120. Since HVAC system 130 is located in an unconditioned space, the air temperature nearby the HVAC system 130 may not necessarily reflect the air temperature monitored by portable thermostat 120 within the conditioned space. Model 172A correlates temperature data between conditioned and unconditioned spaces, which allows the monitoring system to predict the air temperature in the unconditioned space when the portable thermostat 120 is unavailable.

The technique shown in FIG. 4A occurs in a set of steps. In step (1), the system determines that portable thermostat 120 is unable to establish communications with HVAC system 130 and control unit 110. The portable thermostat 120 may be unavailable for various reasons, such as loss of power (e.g., discharged battery), lack of wireless connectivity, or presently malfunctioning (e.g., software malfunction, hardware malfunction). In some instances, the control unit 110 determines that the portable thermostat 120 based on being unable to establish a local wireless connection with the device. This determination can additionally, or alternatively, be based on the server 170 based on monitoring wireless connections over a local area network within property 400 associated with network 105.

At step (2), the control unit 110 communicates with server 170 to identify information specified by model 172A. As shown, model 172A provides a correlation between air temperature in a conditioned space (e.g., living room) and air temperature in an unconditioned space (e.g., utility closet). The correlation can be determined using various machine learning, pattern recognition, and/or tracking technique. In some instances, an air temperature sensor is placed in the unconditioned space during an initial configuration of the monitoring system in property 400. For example, the control unit 110 and/or server 170 may track air temperature measured in the unconditioned space in relation to air temperature measured in the conditioned space. In such instances, the correlation may be an average temperature differential between the air temperatures in the conditioned and unconditioned spaces over the monitoring time period. In other instances, the correlation may be inferred based on monitoring data generated at other properties identified to be similar to property 400. For example, the control unit 110 and/or server 170 may identify similar properties with HVAC systems are also placed in unconditioned spaces (e.g., similar square footage, similar property type, similar location, etc.) and obtain temperature correlation data generated at these properties. In some other instances, the correlation specified by model 172A may be generated based on a combination of data generated in property 400 and data generated at other similar properties. For example, the control unit 110 and/or the server 170 may initially determine the temperature correlation based on data generated at property 400 and then periodically adjust the correlation specified by model 172A based on data obtained from other properties. In some instances, the model 172A can specify a correlation depending on different circumstances at the property 400, for example, the time of day, the season, HVAC operation, among others.

At step (3), the control unit 110 obtains temperature data 402 and set point temperature data 404 from the HVAC system 130. As shown, temperature data 402 identifies an air temperature measured in an unconditioned space (e.g., utility closet), which, in the example, is 64 F. This air temperature may be measured by a temperature sensor associated with HVAC system 130. Set point temperature data 404 identifies a current set point temperature associated with HVAC system 130, which, in the example, is 72 F.

The control unit 110 applies the model 172A to predict an air temperature in the conditioned space (living room) based on temperature data 402 indicating an air temperature in the unconditioned space (utility closet). Given that model 172A identifies that the living room air temperature is typically 10 F higher than the utility closet air temperature, the control unit 110 predicts that the living room temperature is 74 F. The control unit 110 compares the predicted air temperature in the living room to the set point temperature to determine how to configure HVAC system 130. As shown, since the predicted air temperature of 74 F is higher than the set point temperature of 72 F, the control unit 110 determines to initiate a cooling operation.

At step (4), the control unit 110 provides an instruction 406 to HVAC system 130. As shown, instruction 406, when received, causes HVAC system 130 to initiate a cooling operation in property 400. In some instances, the control unit 110 transmits instruction 406 in a similar fashion as portable thermostat 120. For example, the control unit 110 may use a similar wireless communication protocol in transmitting the instruction 406.

At step (5), the control unit 110 provides a notification 410A to user device 150. As shown, the notification 410A includes a message that requests a user to confirm the configuration specified by instruction 406. In this way, a user can confirm an automated change in configuration of the HVAC system 130 when a portable thermostat 120 is unavailable.

In some implementations, the technique depicted in FIG. 4A is performed by server 170. In such implementations, the server 170 accesses information specified by model 172A (step 2), remotely accesses temperature data 402 and set point temperature data 404 (step 3), provides instruction 406 to HVAC system 130 (via WAN) (step 4), and provides notification 410A to user device 150 (step 5). In other implementations, the technique depicted in FIG. 4A is performed by a combination of control unit 110 and server 170.

FIG. 4B shows an example of a table 410 used by control unit 110 when executing the technique shown in FIG. 4A. As shown, the table 410 provides a comparison of operation when portable thermostat 120 has connectivity (i.e., baseline monitoring operation) and operation when portable thermostat 120 has limited or no connectivity (i.e., portable thermostat 120 is unavailable ad unable to communicate with control unit 110 and HVAC system 130). Table 410 identifies three types of input, including driving temperature, mode, and set point. When portable thermostat 120 has wireless connectivity, portable thermostat 120 is configured to determine a driving temperature, mode, and set point based on sensor data (e.g., on-board temperature sensor of portable thermostat 120, environmental sensors placed in conditioned space). Portable thermostat 120 also determines that the mode and set point temperature. In contrast, when portable thermostat 120 has limited or no connectivity, the control unit 110 and/or server 170 models the conditioned space temperature using model 172A, as discussed in reference to FIG. 4A. The control unit 110 and/or server 170 also determines the mode and set point based on monitoring data collected at a property. For example, the control unit 110 may generate a set point temperature based on the most recently configured set point temperature on the portable thermostat 120 and/or the most frequently occurring set point temperature adjustment. As shown in FIG. 4A, the mode of operation may be predicted based on the unconditioned space temperature, the information specified by model 172A, and the set point temperature.

In the example shown in FIG. 4C, a monitoring system uses a model 172B to predict how to adjust a configuration of an HVAC system 130. In this example, the HVAC system 130 is typically regulated by portable thermostat 120 based on comparing an indoor temperature measured by environment sensor 402A with property 400 and the outdoor temperature. However, because portable thermostat 120 is presently unavailable, the control unit 110 performs temperature regulation using model 172B. As shown, model 172B identifies circumstances in which the HVAC system 130 initiates a cooling operation (e.g., when outdoor temperature is 10 F greater than indoor temperature) and circumstances in which the HVAC system 130 initiates a heating operation (e.g., when outdoor temperature is 10 F lower than indoor temperature). In some instances, the model 172B is generated based on historical HVAC activity. For example, the system may monitor circumstances during which the portable thermostat 120 adjusts HVAC system operation and use this information to generate categorical information relating to HVAC system configurations.

The technique shown in FIG. 4C occurs in a set of steps. In step (1), the system determines that portable thermostat 120 is unable to establish communications with HVAC system 130 and control unit 110. As discussed in reference to FIG. 4A, the portable thermostat 120 may be unavailable for various reasons, such as loss of power (e.g., discharged battery), lack of wireless connectivity, or presently malfunctioning (e.g., software malfunction, hardware malfunction). In some instances, the control unit 110 determines that the portable thermostat 120 based on being unable to establish a local wireless connection with the device. This determination can additionally, or alternatively, be based on the server 170 based on monitoring wireless connections over a local area network within property 400 associated with network 105.

At step (2), the control unit 110 communicates with server 170 to identify information specified by model 172B. As shown, model 172B includes historical HVAC operation within the property. The monitoring system in the property 400 can track and update the historical information based on changes to HVAC operation over time. For example, the historical information can be collected over a particular season during which a user likely uses the HVAC system 130 in the same fashion (e.g., using HVAC system 130 for heating during the winter season, using HVAC system 130 for cooling during the summer season). The monitoring system monitors outdoor and indoor temperatures in relation to HVAC operation to develop a correlation between historical HVAC operation and environmental conditions in the property. As shown in FIG. 4C, model 172B includes two examples of historical patterns associated with HVAC operation in property 400. The first pattern indicates that the HVAC system 130 has typically performed a cooling operation for three hours when the outdoor temperature is 10 F higher than indoor temperature. The second pattern indicates that the HVAC system 130 has typically performed a heating operation for two hours when the outdoor temperature is 10 F lower than the indoor temperature.

At step (3), the control unit 110 obtains temperature data 412 from server 170, temperature data 414 from environment sensor 402A, and set point temperature data 416 from the HVAC system 130. As shown, temperature data 412 identifies an outdoor temperature measured nearby the property 400, which, in the example, is 86 F. Temperature data 414 identifies an indoor temperature measured within the property 400, which, in the example, is 74 F. The indoor temperature can be measured by a temperature sensor associated with HVAC system 130, such as environment sensor 402A. Set point temperature data 416 identifies a current set point temperature associated with HVAC system 130, which, in the example, is 72 F.

The control unit 110 applies the model 172B to predict an HVAC configuration based on correlating temperature data 412, temperature data 414, and set point temperature data 416. Given that model 172B identifies that the living room air temperature is typically 10 F higher than the utility closet air temperature, the control unit 110 predicts that the living room temperature is 74 F. The control unit 110 compares the predicted air temperature in the living room to the set point temperature to determine how to configure HVAC system 130. As shown, since the predicted air temperature of 74 F is higher than the set point temperature of 72 F, the control unit 110 determines to initiate a cooling operation. This determination is based on information specified in model data 172, such as the historical trends in HVAC operation represented in model 172B.

At step (4), the control unit 110 provides an instruction 418 to HVAC system 130. As shown, instruction 418, when received, causes HVAC system 130 to initiate a cooling operation in property 400. In some instances, the control unit 110 transmits instruction 418 in a similar fashion as portable thermostat 120. For example, the control unit 110 may use a similar wireless communication protocol in transmitting the instruction 418.

At step (5), the control unit provides a notification 420A to user device 150. The control unit 110 provides a notification 420A to user device 150. As shown, the notification 420A includes a message that requests a user to confirm the configuration specified by instruction 418. In this way, a user can confirm an automated change in configuration of the HVAC system 130 when a portable thermostat 120 is unavailable.

FIG. 4D shows an example of a table 430 used by control unit 110 when executing the technique shown in FIG. 4C. As shown, the table 430 provides a comparison of operation when portable thermostat 120 has connectivity (i.e., baseline monitoring operation) and operation when portable thermostat 120 has limited or no connectivity (i.e., portable thermostat 120 is unavailable ad unable to communicate with control unit 110 and HVAC system 130). Table 430 identifies four types of input, including driving temperature, mode, set point, and outdoor temperature.

When portable thermostat 120 has wireless connectivity or is connected to control dock 130A, portable thermostat 120 is configured to determine a driving temperature, mode, and set point based on sensor data (e.g., on-board temperature sensor of portable thermostat 120, environmental sensors placed in conditioned space). Portable thermostat 120 also determines that the outdoor temperature based on weather data collected by the monitoring system (e.g., server 170). In contrast, when portable thermostat 120 has limited or no connectivity, the control unit 110 and/or server 170 models the conditioned space temperature using model data 170A, as discussed in reference to FIG. 4B. The control unit 110 and/or server 170 also determines the mode, set point, and outdoor temperature based on monitoring data collected at a property. For example, the control unit 110 may generate a set point temperature based on the most recently configured set point temperature on the portable thermostat 120 and/or the most frequently occurring set point temperature adjustment. As shown in FIG. 4C, the mode of operation may be predicted based on prior operation of the HVAC system 130 within the property, information specified by model 172B, the outdoor temperature, and the indoor temperature.

Table 430 also includes a comparison of actions to be performed by the portable thermostat 120 based on set point when portable thermostat 120 has connectivity and when portable thermostat 120 has limited or no connectivity. As shown, when the thermostat 120 has connectivity, the portable thermostat 120 is configured to initiate a heating/cooling operation based on monitoring a driving temperature in relation to a set point temperature (e.g., initiate a heating operation when the driving temperature is below the set point temperature, initiate a cooling operation when the driving temperature is above the set point temperature). In contrast, when the portable thermostat has limited or no connectivity, the control unit 110 and/or the server 170 is configured to compare information specified by the model 172B, an outdoor temperature, and the indoor temperature to configure the HVAC system 130, as shown in FIG. 4C.

In the example shown in FIG. 4E, a monitoring system uses model 172A and 172B to predict how to adjust a configuration of an HVAC system 130. In this example, the HVAC system 130 is located in an unconditioned space, such as a utility closet. This space is unconditioned since it is separate from a conditioned space, such as a living room, that is actively monitored by portable thermostat 120. Since HVAC system 130 is located in an unconditioned space, the air temperature nearby the HVAC system 130 may not necessarily reflect the air temperature monitored by portable thermostat 120 within the conditioned space. Additionally, the HVAC system 130 is typically regulated by portable thermostat 120 based on comparing an indoor temperature measured by environment sensor 402A with property 400 and the outdoor temperature. However, because portable thermostat 120 is presently unavailable, the control unit 110 performs temperature regulation using models 172A and 172B.

As discussed in reference to FIG. 4A, model 172A correlates temperature data between conditioned and unconditioned spaces, which allows the monitoring system to predict the air temperature in the unconditioned space when the portable thermostat 120 is unavailable. Additionally, as discussed in reference to FIG. 4C, model 172B identifies circumstances in which the HVAC system 130 initiates a cooling operation (e.g., when outdoor temperature is 10 F greater than indoor temperature) and circumstances in which the HVAC system 130 initiates a heating operation (e.g., when outdoor temperature is 10 F lower than indoor temperature). Model 172B identifies historical data of HVAC operations previously performed in the property 400. The historical data can identify the type of HVAC operation (e.g., heating operation, cooling operation), the length of the HVAC operations, and the indoor temperature in the conditioned space and the outdoor temperature when the HVAC operations were performed. As discussed in reference to FIG. 4C, the information specified by model 172B can allow the monitoring system to predict how to control the HVAC system 130 when the portable thermostat 120 is unavailable.

The technique shown in FIG. 4E occurs in a set of steps. In step (1), the system determines that portable thermostat 120 is unable to establish communications with HVAC system 130 and control unit 110. The portable thermostat 120 may be unavailable for various reasons, such as loss of power (e.g., discharged battery), lack of wireless connectivity, or presently malfunctioning (e.g., software malfunction, hardware malfunction). In some instances, the control unit 110 determines that the portable thermostat 120 based on being unable to establish a local wireless connection with the device. This determination can additionally, or alternatively, be based on the server 170 based on monitoring wireless connections over a local area network within property 400 associated with network 105.

At step (2), the control unit 110 communicates with server 170 to identify information specified by models 172A and 172B. As shown, model 172A provides a correlation between air temperature in a conditioned space (e.g., living room) and air temperature in an unconditioned space (e.g., utility closet). The correlation can be determined using various machine learning, pattern recognition, and/or tracking technique. Model 172B includes historical HVAC operation that is tracked by monitoring system in the property 400 in relation to indoor and outdoor temperatures.

At step (3), the control unit 110 obtains temperature data 422 from server 170, temperature data 424, and set point temperature data 426 from the HVAC system 130. As shown, temperature data 422 identifies an outdoor temperature measured nearby the property 400, which, in the example, is 86 F. Temperature data 424 identifies an indoor temperature measured within the property 400, which, in the example, is 64 F. The indoor temperature can be measured by a temperature sensor associated with HVAC system 130, such as environment sensor. Set point temperature data 426 identifies a current set point temperature associated with HVAC system 130, which, in the example, is 72 F.

The control unit 110 applies the models 127A and 172B to determine how to configure HVAC system 130. The control unit 110 applies the model 172A to predict an air temperature in the conditioned space (living room) based on temperature data 424 indicating an air temperature in the unconditioned space (utility closet). Given that model 172A identifies that the living room air temperature is typically 10 F higher than the utility closet air temperature, the control unit 110 predicts that the living room temperature is 74 F. The control unit 110 also uses model 172B to predict an HVAC configuration based on correlating predicted temperature in the conditioned space (living room), temperature data 422, and set point temperature data 424. Model 172B identifies that a cooling operation is performed in the property 400 for three hours when the outdoor temperature is 10 F higher than the indoor temperature. As shown, since the outdoor temperature of 86 F is greater than 10 degrees of the predicted temperature of 74 F, the control unit 110 determines to initiate a cooling operation for three hours.

At step (4), the control unit 110 provides an instruction 428 to HVAC system 130. As shown, instruction 428, when received, causes HVAC system 130 to initiate a cooling operation in property 400. In some instances, the control unit 110 transmits instruction 428 in a similar fashion as portable thermostat 120. For example, the control unit 110 may use a similar wireless communication protocol in transmitting the instruction 428.

At step (5), the control unit provides a notification 430A to user device 150. The control unit 110 provides a notification 430A to user device 150. As shown, the notification 430A includes a message that requests a user to confirm the configuration specified by instruction 428. In this way, a user can confirm an automated change in configuration of the HVAC system 130 when a portable thermostat 120 is unavailable.

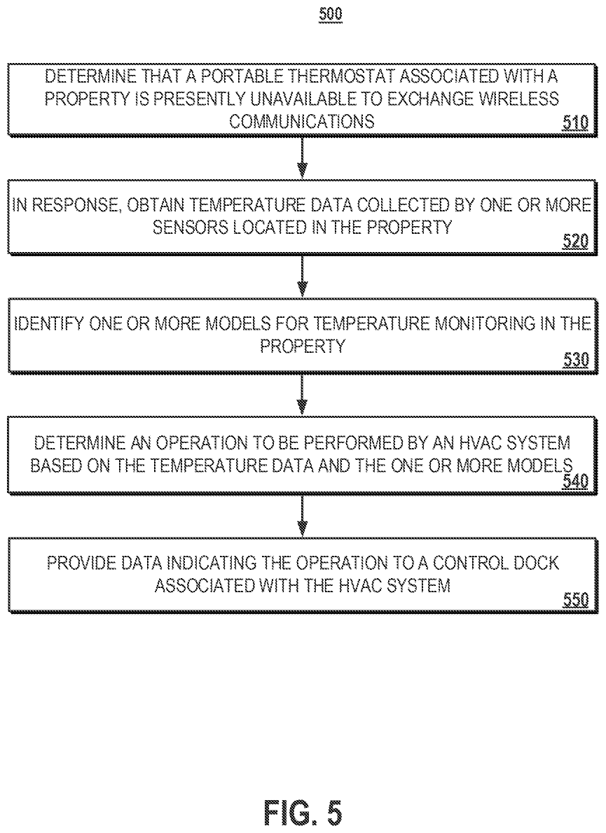

FIG. 5 shows an example of a process 500 for determining an HVAC operation to be performed based on monitoring temperature data generated by environmental sensors of a property. Briefly, the process 500 includes the operations of determining that a portable thermostat associated with a property is presently unavailable to exchange wireless communications (510), obtaining temperature data collected by one or more sensors located in the property (520), identifying one or more models for temperature monitoring in the property (530), determining an operation to be performed by an HVAC system based on the temperature data and the one or more models (540), providing data indicating the operation to a control dock associated with the HVAC system (550).

In more detail, the process 500 includes the operations of determining that a portable thermostat associated with a property is presently unavailable to exchange wireless communications (510). For example, as discussed in reference to FIG. 4A, the system determines that portable thermostat 120 is unable to establish communications with HVAC system 130 and control unit 110. The portable thermostat 120 may be unavailable for various reasons, such as loss of power (e.g., discharged battery), lack of wireless connectivity, or presently malfunctioning (e.g., software malfunction, hardware malfunction). In some instances, the system determines that the portable thermostat 120 based on being unable to establish a local wireless connection with the device. This determination can additionally, or alternatively, be based on the server 170 based on monitoring wireless connections over a local area network within property 400 associated with network 105.

The process 500 includes the operation of obtaining temperature data collected by one or more sensors located in the property (520). For example, as discussed in reference to FIG. 4A, the system can obtain temperature data 402 and set point temperature data 404 from the HVAC system 130. Temperature data 402 identifies an air temperature measured in an unconditioned space (e.g., utility closet), which, in the example, is 64 F. The air temperature may be measured by a temperature sensor associated with HVAC system 130. Set point temperature data 404 identifies a current set point temperature associated with HVAC system 130, which, in the example, is 72 F.

The process 500 includes the operation of identifying one or more models for temperature monitoring in the property (530). For example, as discussed in reference to FIG. 4A, the system can identify model 172A, which provides a correlation between air temperature in a conditioned space (e.g., living room) and air temperature in an unconditioned space (e.g., utility closet). The correlation can be determined using various machine learning, pattern recognition, and/or tracking technique. In some instances, an air temperature sensor is placed in the unconditioned space during an initial configuration of the monitoring system in property 400.

As another example, as discussed in reference to FIG. 4B, the system can identify model 172B, which includes historical HVAC operation within the property. The monitoring system can track and update the historical information based on changes to HVAC operation over time. For example, the historical information can be collected over a particular season during which a user likely uses the HVAC system 130 in the same fashion (e.g., using HVAC system 130 for heating during the winter season, using HVAC system 130 for cooling during the summer season).

The process 500 includes the operation of determining an operation to be performed by an HVAC system based on the temperature data and the one or more models (540). For example, as discussed in reference to FIG. 4A, the system can determine the operation for the HVAC system 130 by applying the model 172A. The system can predict an air temperature in a conditioned space (e.g., living room) based on temperature data 402 indicating an air temperature in the unconditioned space (utility closet). Given that model 172A identifies that the living room air temperature is typically 10 F higher than the utility closet air temperature, the system predicts that the living room temperature is 74 F. The system compares the predicted air temperature in the living room to the set point temperature to determine how to configure HVAC system 130. As shown in FIG. 4A, since the predicted air temperature of 74 F is higher than the set point temperature of 72 F, the system determines to initiate a cooling operation.

The process 500 includes the operation of providing data indicating the operation to a control dock associated with the HVAC system (550). For example, as discussed in reference to FIG. 4A, the system provides an instruction 406 to HVAC system 130. As shown, instruction 406, when received, causes HVAC system 130 to initiate a cooling operation in property 400. In some instances, the system transmits instruction 406 in a similar fashion as portable thermostat 120. For example, the system may use a similar wireless communication protocol in transmitting the instruction 406.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed application-specific integrated circuits (ASICs).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A method for regulating temperature at a property, the method comprising:
determining that a thermostat associated with a property is presently unavailable to send or receive a wireless communication;
obtaining temperature data collected by one or more sensors located at the property;
identifying one or more models for temperature monitoring at the property;
determining an operation to be performed by an HVAC system based on the temperature data and the one or more models; and
providing data indicating the operation to the HVAC system.

2. The method of claim 1, wherein:
the one or more models comprise a machine learned model trained to predict a temperature of a conditioned space.

3. The method of claim 1, wherein the one or more models comprise a statistical correlation model to predict a temperature of a conditioned space.

4. The method of claim 1, wherein the one or more models correlate temperature data between conditioned and unconditioned spaces at the property.

5. The method of claim 4, wherein the HVAC system is located in an unconditioned space of the unconditioned spaces.

6. The method of claim 1, wherein the operation to be performed by the HVAC system comprises one or more of (i) initiating or terminating a heating or cooling operation, (ii) adjusting an operating mode of the HVAC system, (iii) adjusting configurations of one or more components of the HVAC system, or (iv) adjusting a set point temperature of the HVAC system.

7. The method of claim 1, wherein determining that the thermostat associated with the property is presently unavailable to exchange wireless communications comprises:
determining a control unit of the HVAC system is unable to establish a local wireless connection with the thermostat.

8. The method of claim 1, wherein determining that the thermostat associated with the property is presently unavailable to exchange wireless communications comprises:
monitoring wireless connections over a local area network of the property.

9. The method of claim 1, comprising:
updating the one or more models for temperature monitoring at the property.

10. The method of claim 9, comprising:
obtaining data from other properties; and
updating the one or more models for temperature monitoring at the property using the obtained data from the other properties.

11. The method of claim 1, wherein obtaining the temperature data collected by the one or more sensors located at the property comprises:
obtaining data from a temperature sensor indicating an air temperature in an unconditioned space.

12. The method of claim 1, wherein determining the operation to be performed by the HVAC system based on the temperature data and the one or more models comprises:
obtaining a set point temperature from the one or more models using the temperature data; and
determining the operation to be performed by the HVAC system as (i) a cooling operation if the set point temperature is below an air temperature indicated by the temperature data.

13. The method of claim 1, wherein determining the operation to be performed by the HVAC system based on the temperature data and the one or more models comprises:
obtaining a set point temperature from the one or more models using the temperature data; and
determining the operation to be performed by the HVAC system as (i) a heating operation if the set point temperature is above an air temperature indicated by the temperature data.

14. The method of claim 1, wherein providing the data indicating the operation to the HVAC system comprises:
providing data indicating the operation to a control dock associated with the HVAC system.

15. The method of claim 1, comprising:
obtaining weather data for the property; and
wherein determining the operation to be performed by the HVAC system comprises:
determining the operation to be performed by the HVAC system based on (i) the temperature data, (ii) the one or more models, and (iii) the obtained weather data.

16. The method of claim 1, wherein determining that the thermostat associated with the property is presently unavailable to send or receive the wireless communication comprises:
determining the thermostat is unavailable to send or receive one or more particular types of wireless communications.

17. The method of claim 1, wherein the thermostat is a portable thermostat.

18. A non-transitory computer-readable medium storing one or more instructions executable by a computer system to perform operations comprising:
determining that a thermostat associated with a property is presently unavailable to send or receive a wireless communication;
obtaining temperature data collected by one or more sensors located at the property;
identifying one or more models for temperature monitoring at the property;
determining an operation to be performed by an HVAC system based on the temperature data and the one or more models; and
providing data indicating the operation to the HVAC system.

19. The medium of claim 18, wherein:
the one or more models comprise a machine learned model trained to predict a temperature of a conditioned space.

20. A system, comprising:
one or more processors; and
machine-readable media interoperably coupled with the one or more processors and storing one or more instructions that, when executed by the one or more processors, perform operations comprising:
determining that a thermostat associated with a property is presently unavailable to send or receive a wireless communication;
obtaining temperature data collected by one or more sensors located at the property;
identifying one or more models for temperature monitoring at the property;
determining an operation to be performed by an HVAC system based on the temperature data and the one or more models; and
providing data indicating the operation to the HVAC system.
